(19) United States
(12) Patent Application Publication
(10) Pub. No.: US 2011/0169273 A1
(43) Pub. Date: Jul. 14, 2011

(54) HYBRID ENERGY CONVERSION SYSTEM

(75) Inventor: Alan Martin, Shell Beach, CA (US)

(73) Assignee: ARB GREENPOWER, LLC, Honolulu, HI (US)

(21) Appl. No.: 13/119,239

(22) PCT Filed: Jan. 24, 2009
(86) PCT No.: PCT/US09/31921

§ 371 Date: Mar. 16, 2011

Related U.S. Application Data
(60) Provisional application No. 61/100,521, filed on Sep. 26, 2008.

(51) Int. Cl. H02K 7/18

(52) U.S. Cl. 290/1 A; 180/65.275; 903/903

(57) ABSTRACT

A hybrid energy conversion system is described which utilizes a drive engine configured to output mechanical energy at a generally uniform rotational speed under varying mechanical load conditions. The mechanical energy is used to turn an electrical generator mechanically coupled to the drive engine. The electrical energy output from the electrical generator is then used to power an electrical motor coupled to a mechanical load.

### CROSS REFERENCE TO RELATED APPLICATIONS

This application is a non-provisional application which claims benefit and priority under 35 U.S.C. §119(e) from the applicant's co-pending U.S. provisional application Ser. No. 61/100,521, filed on Sep. 26, 2008. This application is also related to expired U.S. provisional application Ser. No. 60/913,245, filed Apr. 20, 2007. The aforementioned provisional applications are hereby incorporated by reference in their entirety as if fully set forth herein.

### RELEVANT INVENTIVE FIELD

The present inventive embodiments relate generally to energy conversion systems, and more specifically for an energy conversion system suitable for propulsion and other implementation.

### BACKGROUND

Traditional energy conversion systems generally rely on fossil fueled engines which convert chemical energy into mechanical energy. To release the chemical energy contained in fossil fuels, the fuel is combusted under controlled conditions, typically in a combustion chamber. The combustion process relies on an air-fuel mixture which combines oxygen with the fossil fuel which liberates the chemical energy as heat and pressure which is then converted into usable mechanical energy. Energy conversion using fossil fuels suffers from a number of disadvantages including but not limited to relatively low chemical energy to mechanical energy conversion efficiency, production of toxic chemical byproducts and production of greenhouse gases to name a few.

As supplies of readily available fossil fuels decline, alternatives to the sole use of fossil fuels are being sought. For example, fossil fuels are used extensively in motor vehicles which are a major contributor to the production of smog and greenhouse gases. To reduce smog, greenhouse gas emissions and reliance on usage of fossil fuels, hybrid propulsion systems are being developed which convert electrical energy into mechanical energy. Hybrid propulsion systems provide greater energy conversion efficiency and release considerably less toxic byproducts and greenhouse gases.

Accordingly, hybrid energy conversion systems adaptable to a wide variety of vehicular and other implementations are highly desirable and necessary to preserve available fossil fuel reserves for non-transportation needs and protection of the global environment.

### SUMMARY

A hybrid energy conversion system is described which utilizes a drive engine configured to output mechanical energy at a generally uniform rotational speed under varying mechanical load conditions. The mechanical energy is used to turn a rotor of an electrical generator mechanically coupled to the drive engine. The type of drive engine used to turn the rotor of the electrical generator may be of any type. By way of examples and not limitations; a steam engine, an electrical motor, an internal combustion engine, a wind turbine, a turbine engine, a pneumatic engine, or a hydraulic engine may be used to achieve a particular design objective.

The electrical generator utilizes several rare earth magnets affixed radially and uniformly to a rotor turned by the drive engine to induce an electrical energy flow in stator windings of the electrical generator. The rare earth magnets are generally constructed from alloys of neodymium or samarium. Each rare earth magnet generates a surface field of at least 5,000 gauss. The electrical energy output from the electrical generator is typically about 10 kilowatts, but may be scaled either smaller or larger to accommodate a particular design objective.

The electrical energy output from the electrical generator is then used to power an electrical motor operating under a generally uniform mechanical load. The type of electrical motor may be a direct current series wound motor, a permanent magnet direct current motor or a three phase alternating current induction motor.

An electrical energy storage unit is connected in parallel with the output of the electrical generator. The electrical energy storage unit includes a capacitive energy storage cell configured to provide a reservoir of electrical energy sufficient to compensate for temporary electrical energy shortfalls where electrical energy demands of the electrical motor exceed the electrical energy output from the electrical generator. The electrical energy storage unit may also include one or more battery cells. At other times where electrical energy generation exceeds the electrical energy demand of the electrical motor, the electrical energy storage unit may be charged by the electrical generator. Charging of the electrical energy storage unit typically occurs during declining mechanical load conditions.

An electrical controller is provided to regulate the flow of electrical energy from the electrical generator and/or the electrical energy storage unit to the electrical motor. An electrical regulator may also be provided to regulate electrical energy flow to and from the electrical energy storage unit. The electrical regulator controls the rate of charging and discharging of the electrical energy storage unit. The electrical regulator may be incorporated into a circuit of the electrical generator, electrical energy storage unit or electrical controller.

Depending on the type of electrical motor used, the hybrid energy conversion system may also include a direct current to alternating current inverter configured to provide alternating current to a three phase alternating current induction motor.

### BRIEF DESCRIPTION OF DRAWINGS

The features and advantages will become apparent from the following detailed description when considered in conjunction with the accompanying drawings. Where possible, the same reference numerals and characters are used to denote like features, elements, components or subsystems. Components shown in dotted lines are intended to illustrate optional equipment or the inventive environment. It is intended that changes and modifications can be made to the various described embodiments without departing from the true scope and spirit of the subject inventive embodiments as defined in principal by the claims.

FIG. 1—depicts a generalized schematic view of a hybrid energy conversion system in accordance with an exemplary embodiment.

FIG. 1A—depicts a generalized schematic view of an electrical generator in accordance with an exemplary embodiment.

FIG. 2—depicts a vehicular implementation of a hybrid energy conversion system in accordance with an exemplary embodiment.

FIG. 3A—depicts a motor boat implementation of a hybrid energy conversion system in accordance with an exemplary embodiment.

FIG. 3B—depicts another motor boat implementation of a hybrid energy conversion system in accordance with an exemplary embodiment.

FIG. 4A—depicts a stationary implementation of a hybrid energy conversion system in accordance with an exemplary embodiment.

FIG. 4B—depicts another stationary implementation of a hybrid energy conversion system in accordance with an exemplary embodiment.

### DETAILED DESCRIPTION

A hybrid energy conversion system is described which utilizes a drive engine configured to output mechanical energy at a generally uniform rotational speed under varying mechanical load conditions. The mechanical energy is used to turn a rotor of an electrical generator mechanically coupled to the drive engine.

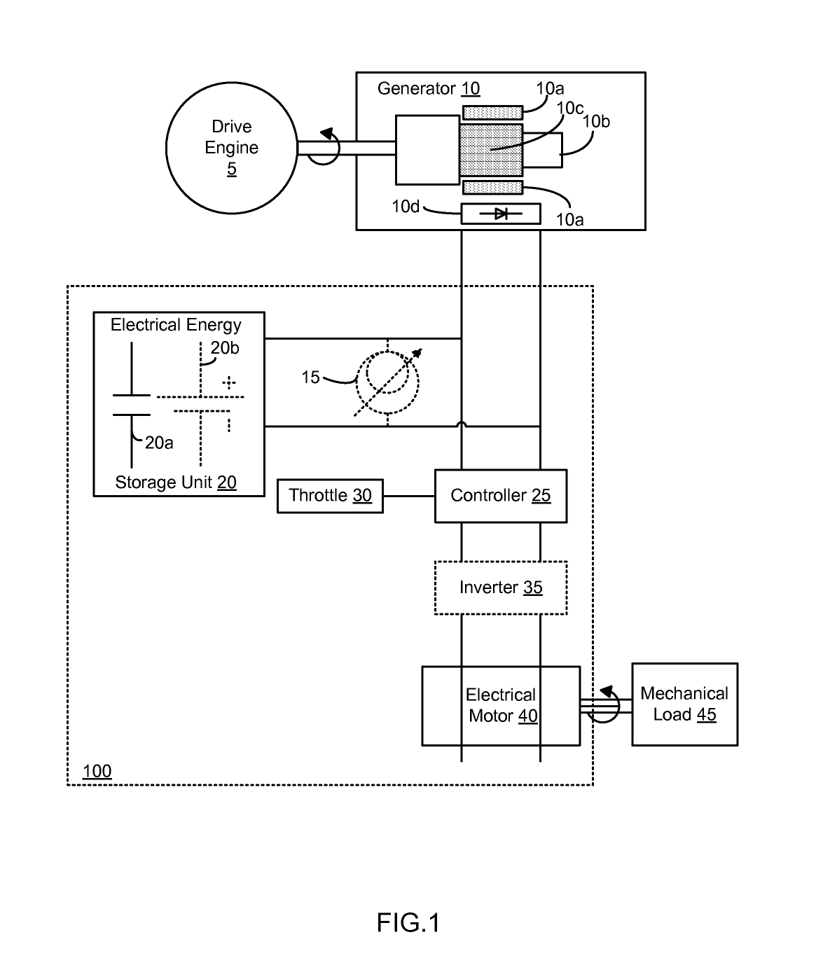

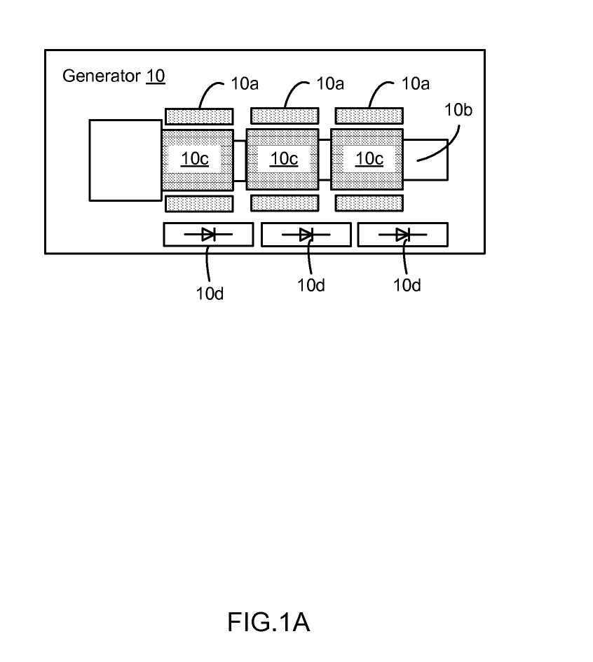

Referring to FIG. 1, a generalized schematic view of a hybrid energy conversion system is depicted in accordance with an exemplary embodiment. In an embodiment, a drive engine 5 is shown mechanically coupled to a rotor 10b of an electrical generator 10. The drive engine 5 is used to turn the rotor 10b of the electrical generator 10. The type of drive engine 5 used to turn the rotor 10b of the electrical generator 10 may be of any type. As examples and not limitations; a steam engine, an electrical motor, an internal combustion engine, a wind turbine, a turbine engine, a pneumatic engine, or a hydraulic engine may be used to achieve a particular design objective. The drive engine 5 is configured to operate at a generally constant rotational speed when the electrical generator 10 is operated at full output capacity. For a typical four cylinder 4 cycle internal combustion engine, the rotational speed is generally about 3,000 rotations per minute. The actual rotational speed of the drive engine 5 may be varied to accommodate and/or optimize the operation of other drive engine types. Selection of the drive engine 5 used to turn the rotor 10b of the electrical generator 10 should include consideration of fuel consumption, engine duty cycle, engine efficiency and minimization of the production of undesirable combustion byproducts where applicable.

The electrical generator 10 further includes a plurality of stationary stator windings 10a, and a plurality of rare earth magnets 10c affixed to the rotor 10b. The stator windings 10a are cumulatively dimensioned to carry an electrical current of at least 100 amperes continuously when used for vehicle propulsion implementations. The wire gauge of the stator windings 10a may be dimensioned based on three phase alternating current rather than direct current, thus reducing the overall weight and cost of the electrical generator 10.

The rare earth magnets 10c are configured to induce electrical energy flow (current flow) in the stator windings 10a of the electrical generator 10 when the rotor 10b is turned by the drive engine 5. The rare earth magnets 10c replace the direct current field windings typically used to form an electromagnet in contemporary vehicular alternators. As such, the use of rare earth magnets 10c allows the electrical generator 10 to be self-exciting.

In an embodiment, the induced electrical energy flow is rectified by a plurality of rectifiers 10d which converts internally generated three phase alternating current (AC) to direct current (DC). The rectifier arrangement is equivalent to those included in contemporary alternator design and are dimensioned to continuously output 100 amperes for vehicle propulsion implementations. The electrical generator output voltage is typically in a range of 100-150 volts DC.

The electrical energy output from the electrical generator 10 is regulated by an electrical controller 25. The electrical controller 25 regulates the electrical energy flow to an electrical motor 40 used to drive a mechanical load 45. In an embodiment, a throttle 30 is electrically coupled to the electrical controller 25. The throttle 30 is configured to allow a user to control the electrical energy flow from the electrical controller 25 to the electrical motor 40. The throttle 30 may be configured as a gas pedal, lever or dial for controlling the energy flow to the electrical motor 40. Suitable commercially manufactured controllers are available from Cloud Electric Vehicles, 204 Ellison St, Clarkesville, Ga. 30523 (e.g., Controller Curtis 1231C-8601), Kelly Controllers, www.kellycontroller.com (e.g., kdh14650b); EV Source LLC, 695 West 1725 N, Logan, Utah 84321 (e.g., Zilla Z1K). Many of the commercially manufactured electrical controllers provide a computer communications interface (e.g., RS-232C) which allows for the setting of various electrical controller parameters and/or automated control of various controller functions during operation.

The electrical motor 40 may be a DC series wound motor, a permanent magnet DC motor or a three phase AC induction motor. For vehicle implementations, the electrical motor operates in a voltage range of 100-150 volts. In embodiments where a three phase AC induction motor is utilized, an inverter 35 is provided to convert the rectified DC voltage output from the electrical generator 10 to three phase AC. Suitable commercially manufactured inverters are available from Metric Mind Corporation, 9808 SE Derek Court, Happy Valley, Oreg. 97086. One advantage of utilizing a three phase AC induction motor is to provide regenerative braking in vehicle implementations, whereby the AC induction electrical motor 40 acts as a supplemental electrical generator during vehicle braking. Another advantage of using an AC induction motor is the reduction in the wire gauge necessary to transfer electrical energy to the electrical motor 40.

Suitable commercially manufactured motors are available from D&D Motor Systems, Inc., 215 Park Avenue, Syracuse, N.Y. 13204 (e.g., ES-31B, ES-63); Cloud Electric Vehicles, 204 Ellison St, Clarkesville, Ga. 30523 (e.g., Advanced DC FB1-4001A); EV Source LLC, 695 West 1725 N, Logan, Utah 84321 (e.g., TransWarp 9). For vehicle implementations, an electrical motor 40 having a horsepower (HP) rating in a range of 10-100 is generally sufficient.

In an embodiment, an electrical energy storage unit 20 is electrically coupled in parallel with the electrical generator 10 and electrical motor 40. The electrical energy storage unit 20 provides additional electrical energy to the electrical motor 40 when the electrical energy output capacity of the electrical generator 10 is temporarily exceeded. A regulator 15 is electrically coupled in parallel with the electrical energy storage unit 20 for regulating electrical charging and discharging from the electrical energy storage unit 20. The regulator 15 may be incorporated directly into a circuit associated with the electrical generator 10, electrical energy storage unit 20 or electrical controller 25. Suitable commercially manufactured regulators are available from American Power Design, Inc., 3 Industrial Drive, Windham, N.H. 03087.

In an embodiment, the electrical energy storage unit 20 is configured as capacitive storage 20a. In another embodiment, the electrical energy storage unit 20 further includes battery storage 20b, which is wired in parallel with the capacitive storage 20a. Suitable, commercially available electrical energy storage units are manufactured by Xstatic Corporation, LLC, 9540 West US 84, Newton, Ala. 36352 (e.g., BATCAP 2000); Maxwell Technologies, 9244 Balboa Avenue, San Diego, Calif. 92123 (e.g., BoostCap HTM series). For motor vehicle implementations, the electrical energy storage unit 20 should provide at least 25 kilowatts of peak electrical energy.

In an embodiment, the electrical generator 10 is constructed to output 100-150 volts DC at a continuous current rating of 100-150 amperes (22.5 kW). However, as discussed above, the sizing of the electrical generator 10 is determined by the anticipated demands generated by the mechanical load 45. One skilled in the art will appreciate that scaling of the various components included in the hybrid electrical energy conversion system may be accomplished to meet a particular design objective.

In an embodiment, the rare earth magnets 10c are constructed from either neodymium or samarium metal alloys and generate surface magnetic field strengths of at least 5,000 gauss. The rare earth magnets 10c are affixed to the rotor using fasteners. Each of the rare magnets 10c may include an austenitic cladding or coating to protect their more brittle rare earth metal alloy.

In an embodiment, fourteen rare earth magnets 10c are radially and uniformly disposed on a shaft which forms the rotor 10b. One skilled in the art will appreciate that the number of rare earth magnets 10c may be varied to accommodate a particular design objective.

Where necessary to meet a particular design objective, one or more additional electrical generators 10, electrical energy storage units 20, electrical controllers 25, and/or electrical motors 40 may be provided in parallel to the basic hybrid energy conversion system shown in FIG. 1. Likewise, a ganged configuration of the electrical generator 10 in which multiple sets of rare earth magnets 10c may be attached to a common rotor 10b and multiple parallel stators 10a are provided in order to accommodate a particular design objective. An example the ganged configuration for electrical generator 10 is shown in FIG. 1A. One skilled in the art will appreciate that fewer or greater rotor and stator assemblies may be provided to accommodate a particular design objective.

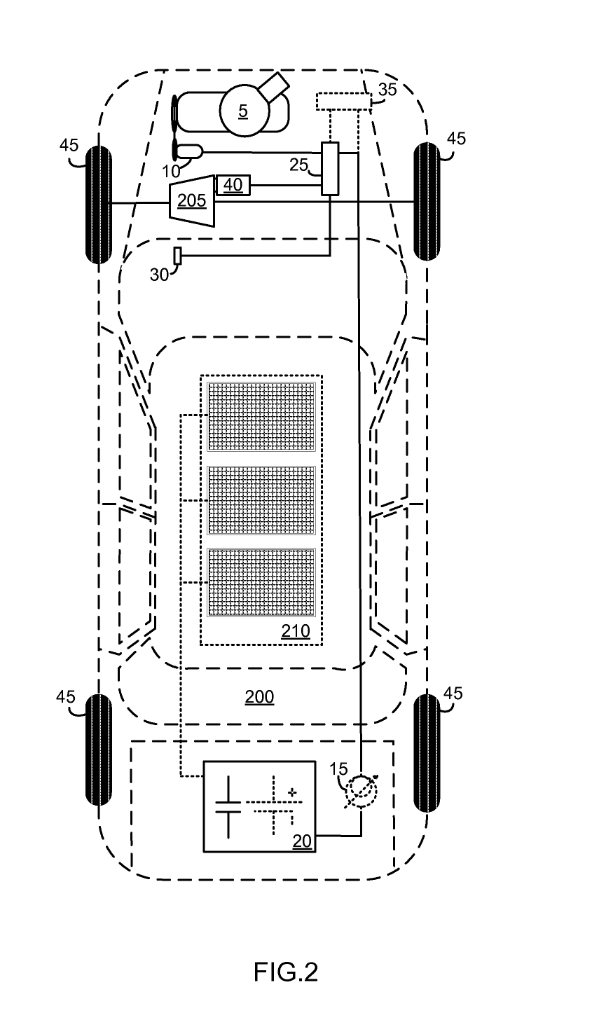

Referring to FIG. 2, a vehicular implementation of a hybrid energy conversion system is depicted in accordance with an exemplary embodiment. In an embodiment, an internal combustion engine 5 is used to turn the electrical generator 10. The electrical energy output from the electrical generator 10 is fed through a electrical controller 25. Electrical energy flow is regulated by the electrical controller 25 in which a throttle 30 configured as a gas pedal is provided. The gas pedal allows a driver of the vehicle 200 to control the electrical energy flow to the electrical motor 40. The horsepower rating of the internal combustion engine 5 should be equal to or greater than the horsepower required to turn the rotor 10b (FIG. 1) of the electrical generator 10 under full mechanical load conditions.

In this vehicular embodiment, the electrical motor 40 is mechanically coupled to a transmission 205 which transfers mechanical energy output by the electrical motor 40 to the mechanical load (wheels) 45 of the vehicle. The transmission 205 may be of a standard motor vehicle manual or automatic transmission types. Alternately, continuously variable transmissions currently manufactured by Toyota, Honda, Mazda, Ford, GMC, BMW, and DaimlerChrysler may be used as well.

In an embodiment, the internal combustion engine 5 may be replaced with another drive engine type. For example, an electrical motor (not shown) may used in certain vehicle implementations where a charging electrical source is provided to maintain the electrical energy storage unit 20. In this example, an array of solar panels 210 may be provided to charge and maintain the electrical energy storage unit 20.

The placement of the electrical energy storage unit 20 is arbitrarily shown in the rear of the vehicle 200. One skilled in the art will appreciate that the physical placement of hybrid energy conversion system components may vary in order to meet a particular design objective.

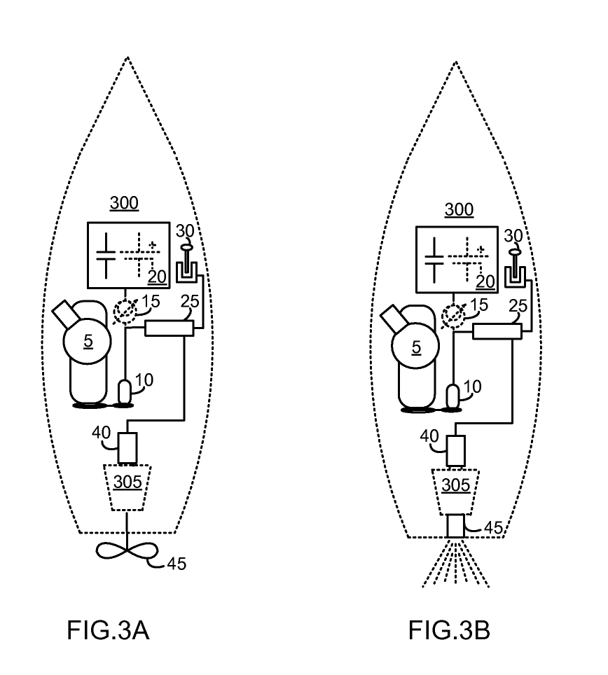

Referring to FIGS. 3A and 3B, motor boat implementations of a hybrid energy conversion system in accordance with an exemplary embodiment is depicted. In this embodiment, a hybrid energy conversion system which utilizes an internal combustion engine 5 is used to turn the rotor 10b of generator 10 by way of a common fan-belt arrangement. In an embodiment, the electrical energy output from the electrical generator 10 is fed through a electrical controller 25 as described above. Electrical energy flow is controlled by the electrical controller 25 in which a throttle 30 configured as a lever 30 is provided. The lever 30 allows a driver of the motor boat 300 to control the electrical energy flow to the electrical motor 40 and thus the speed of the motor boat.

In a motor boat embodiment, the electrical motor 40 is mechanically coupled to a transmission 305 which transfers mechanical energy output provided by the electrical motor 40 to a mechanical load 45. In FIG. 3A, the mechanical load 45 is a propeller used to propel the motor boat 300. In FIG. 3B, the mechanical load 45 is a jet thrust engine which propels the motor boat 300 by the discharge of a high pressure water jet. One skilled in the art will appreciate that the transmission 305 may be made optional in direct drive implementations where the electrical motor 40 is coupled directly to a shaft which drives the propeller 45 (FIG. 3A) or jet drive 45 (FIG. 3B).

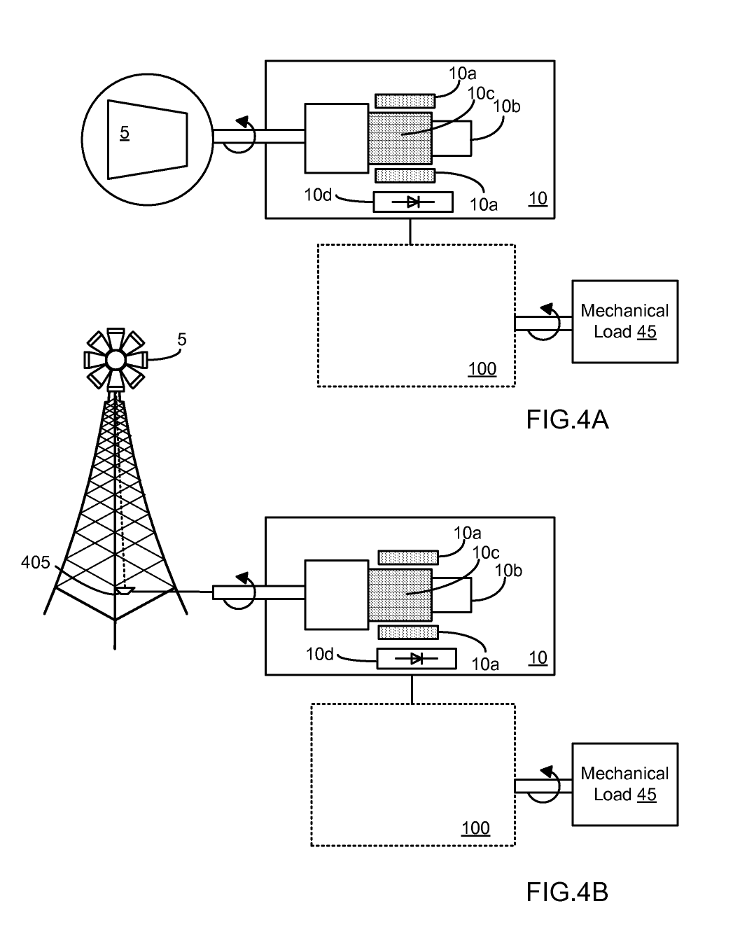

Referring to FIGS. 4A and 4B, stationary implementations of a hybrid energy conversion system in accordance with an exemplary embodiment is depicted. The main components of the hybrid energy conversion system (e.g., electrical energy storage unit 20, electrical controller 35, electrical motor 40), shown in FIG. 1 should be assumed to be included within block 100.

In an embodiment, the drive engine 5 is configured as a turbine engine. Turbine engines are considered suitable for implementations where the mechanical energy necessary to drive the mechanical load 45 remains generally constant, for example, pumping and/or irrigation implementations. In FIG. 4B, a wind turbine may be used as the drive engine 5 which turns the rotor 10b of the electrical generator 10. In an embodiment, a transmission 405 may be used to transfer the mechanical energy generated by the wind turbine 5 to the electrical generator 10. Alternately, the wind turbine 5 may be used to power a motor-generator set (not shown) which is then used to turn the rotor 10b of the electrical generator 10.

The foregoing described exemplary embodiments are provided as illustrations and descriptions. They are not intended to limit the various inventive embodiments to any precise form and structure described. In particular, it is contemplated that functional implementation may be performed using any compatible type of component of the hybrid energy conversion system including the electrical generator 10, regulator 15, electrical energy storage unit 20 (FIG. 1), electrical controller 25 (FIG. 1), or electrical motor 40 (FIG. 1). No specific limitation is intended for placement of a particular component or type of component, or number of like components used to accomplish a particular design objective. Other variations and embodiments are possible in light of above teachings, and it is not intended that this Detailed Description limit the scope of the inventive embodiments, but rather by the Claims following herein.

What is claimed:

1. A hybrid energy conversion system comprising:
a drive engine configured to output mechanical energy at a generally uniform rotational speed under varying mechanical load conditions;
an electrical generator mechanically coupled to said drive engine, said electrical generator comprising a plurality of rare earth magnets affixed to a rotor of said electrical generator, said plurality of rare earth magnets configured to induce an electrical energy flow in a stator of said electrical generator sufficient to power an electrical motor operating under a generally uniform mechanical load when said rotor is turned by said drive engine;
an electrical energy storage unit electrically coupled in parallel with an output of said electrical generator, said electrical energy storage unit having a capacitive energy storage cell configured to provide an electrical energy storage capacity sufficient to compensate for at least a portion of any electrical energy output shortfall from said electrical generator;
an electrical controller electrically coupled in parallel with said output of said electrical generator and said electrical energy storage unit, said electrical controller configured to control electrical energy flow to said electrical motor.

2. The hybrid energy conversion system of claim 1 wherein said drive engine is selected from the group consisting of a steam engine, an electrical motor, an internal combustion engine, a wind turbine, a turbine engine, a pneumatic engine, and a hydraulic engine.

3. The hybrid energy conversion system of claim 1 wherein said plurality of rare earth magnets are constructed from alloys of neodymium or samarium.

4. The hybrid energy conversion system of claim 1 wherein said electrical storage unit further includes one or more battery cells.

5. The hybrid energy conversion system of claim 1 wherein said electrical energy storage unit is charged using excess electrical energy generated by said electrical generator during a declining mechanical load condition.

6. The hybrid energy conversion system of claim 5 further comprising an electrical regulator for regulating electrical energy flow to and from said electrical energy storage unit.

7. The hybrid energy conversion system of claim 6 wherein said electrical regulator regulates the rate of charge and discharge electric energy to and from said electrical energy storage unit in dependence on variations in said mechanical load condition.

8. The hybrid energy conversion system of claim 1 wherein said electric motor is selected from the group consisting of a direct current series wound motor, a permanent magnet direct current motor and a three phase alternating current induction motor.

9. The hybrid energy conversion system of claim 8 further comprising a direct current to alternating current inverter configured to provide sufficient electrical energy for said three phase alternating current induction motor.

10. The hybrid energy conversion system of claim 1 wherein said electrical energy generator has an electrical energy output capacity of at least 10 kilowatts.

11. The hybrid energy conversion system of claim 1 wherein each of said rare earth magnets generates a surface field of at least 5,000 gauss.

12. A hybrid energy conversion system comprising:
an internal combustion engine configured to output mechanical energy at a generally constant rotational speed under varying mechanical load conditions;
an electrical generator mechanically coupled to said internal combustion engine, said electrical generator comprising a plurality of rare earth magnets affixed to a rotor of said electrical generator and configured to induce an electrical energy flow in a stator of said electrical generator sufficient to power an electrical motor operating under a generally constant mechanical load condition when said rotor is turned by said engine;
an electrical energy storage unit electrically coupled in parallel with an output of said electrical generator, said electrical energy storage unit having a capacitive energy storage cell configured to provide an electrical storage capacity sufficient to compensate for at least a portion of any electrical energy output shortfall from said electrical generator when said electrical motor encounters a varying mechanical load condition;
an electrical controller electrically coupled in parallel with said output of said electrical generator and said electrical energy storage unit, said electrical controller configured to control electrical energy flow to said electrical motor;
wherein said electrical motor is configured to output mechanical energy to a mechanical load.

13. The hybrid energy conversion system of claim 12 wherein the mechanical load includes a wheel, a propeller or a jet nozzle.

14. The hybrid energy conversion system of claim 13 wherein said mechanical load further includes a transmission.

15. The hybrid energy conversion system of claim 12 wherein said electrical energy storage unit is configured to output at least 25 kilowatts peak.

16. The hybrid energy conversion system of claim 12 wherein said electrical motor is configured to output at least 20 horsepower.

17. A hybrid energy conversion system comprising:
an internal combustion engine configured to output mechanical energy at a generally constant rotational speed under varying mechanical load conditions;
an electrical generator mechanically coupled to said internal combustion engine, said electrical generator comprising a plurality of neodymium alloy magnets affixed to a rotor of said electrical generator and configured to induce an electrical energy flow in a stator of said electrical generator sufficient to power an electrical motor operating under a generally constant mechanical load condition when said rotor is turned by said internal combustion engine;
an electrical energy storage unit electrically coupled in parallel with an output of said electrical generator, said electrical energy storage unit having a capacitive energy storage cell configured to provide an electrical storage capacity sufficient to compensate for at least a portion of any electrical energy output shortfall from said electrical generator when said electrical motor encounters a varying mechanical load condition;
an electrical controller electrically coupled in parallel with said output of said electrical generator and said electrical energy storage unit, said electrical controller configured to control electrical energy flow to said electrical motor;
a transmission mechanically coupled to said electrical motor configured to transfer mechanical output from said electrical motor to at least one wheel of a vehicle.

18. The hybrid energy conversion system of claim 17 wherein said electrical generator comprises at least 14 neodymium or samarium alloy magnets.

19. The hybrid energy conversion system of claim 17 wherein said electric motor is selected from the group consisting of a direct current series wound motor, a permanent magnet direct current motor and a three phase alternating current induction motor.

20. The hybrid energy conversion system of claim 17 wherein said electrical energy storage unit is configured to output at least 25 kilowatts peak.
